(19) United States
(12) Patent Application Publication
(10) Pub. No.: US 2020/0404921 A1
(43) Pub. Date: Dec. 31, 2020

(54) SOIL TREATMENT WITH METAM SALTS AND ONE OR MORE OF CALCIUM THIOSULFATE, CALCIUM CHLORIDE AND CALCIUM NITRATE

(71) Applicant: Tessenderlo Kerley, Inc., Phoenix, AZ (US)

(72) Inventors: Michael Massoud Hojjatie, Tucson, AZ (US); Kurt Carl Volker, Yakima, WA (US); Kyle England Coleman, Kennewick, WA (US); Bernard Oscar Olsen, Paso Robles, CA (US)

(21) Appl. No.: 16/969,181

(22) PCT Filed: Feb. 20, 2019
(86) PCT No.: PCT/US2019/018782

§ 371 Date: Aug. 11, 2020

Related U.S. Application Data
(60) Provisional application No. 62/633,547, filed on Feb. 21, 2018.

(51) Int. Cl. A01N 47/14; A01N 59/02; A01N 59/08

(52) U.S. Cl. CPC A01N 47/14; A01N 59/08; A01N 59/02

(57) ABSTRACT

A stable concentrated solution of a metam salt and one or more of calcium thiosulfate, calcium chloride and calcium nitrate, can be used to treat for soil pathogens, including the pathogen responsible for potato early die. It is believed that the high concentrations of the compounds, that is, the high concentration of calcium thiosulfate, calcium chloride and/or calcium nitrate admixed with a metam, results in lower rates of degradation that result from calcareous soil, increased soil adsorption or retention, and improved distribution of metam or methyl isothiocyanate (MITC) in the soil.

### CROSS-REFERENCE TO RELATED APPLICATIONS

This application is the U.S. national stage of PCT/US2019/018782 filed Feb. 20, 2019, and claims priority to U.S. provisional application No. 62/633,547 filed Feb. 21, 2018, both of which are hereby incorporated herein by reference for all that they each disclose.

### FIELD OF THE INVENTION

The invention relates to a stable concentrated solution of a fumigant and an inorganic compound, wherein said inorganic compound is one or more of calcium thiosulfate, calcium chloride and calcium nitrate, and wherein said fumigant is preferably an alkali salt of metam. The invention also relates to treating soil, particularly soil to be used for growing root, tuber and bulb vegetable crops, cucurbits, leafy vegetables, fruiting vegetables, small fruit and strawberries, with the concentrated solution of a fumigant and said inorganic compound. Advantageously the calcium thiosulfate, calcium chloride and/or calcium nitrate is incorporated into the soil as a concentrated solution, and the treatment is incorporated into or displaced down to a depth of 4 inches or more, for example 8 inches or more.

### BACKGROUND

Root and bulb vegetable crops such as carrots, onions, potatoes and other root/tuber vegetables are particularly subject to attack by various soil-borne pathogens. Potatoes in particular are an important crop subject to attack from the pathogen Verticillium dahliae (“Vert”, “V. dahlia”, or “Verticillium”) also known as Verticillium wilt and as potato early die. Verticillium wilt of potato occurs wherever potatoes are grown. Yields of potatoes grown in infested soils may be 30-50% lower than yields on non-infested land. In some varieties, the discoloration of the vascular tissue in tubers results in tuber quality reduction.

Phytophthora infestans causes late blight and attacks both tubers and foliage. Control of late blight is reliant on multiple applications of fungicide during the growing season. Some areas have such infection pressure they may require 10+ fungicide applications for control of late blight. Rotation of fungicides is very important to avoid development of resistance, although there are some standard fungicides that have been used consistently for years/decades. Late blight also attacks tomatoes.

Verticillium wilt, caused by Verticillium dahliae and Verticillium alboatrum, affects many plant species including herbaceous annuals (for example, potato), perennials (for example, peppermint), and woody species (for example, maple). Other examples of susceptible crops include cabbage, celery, cucumber, eggplant, lettuce, melons, pepper, potato, pumpkin, radish, rhubarb, and tomato. These pathogens can persist in soil for many years in the absence of a susceptible crop. Infection is through the roots, and therefore treatment of the disease is difficult. Verticillium propagules occur in highest concentration in the top 12 inches of the soil, but can reside at depths as low as 16 inches. Crop rotation does not control the pathogen because the microsclerotia persist in soil for years. Planting non-susceptible crops for several consecutive seasons does not lead to significant reductions in the populations of microsclerotia.

Application of soil fumigants to the soil profile provides effective control in many soils. Fumigants are typically applied through either shank injectors or irrigation systems in either the fall or the spring. Fumigants to suppress and/or control soil-borne pests may be applied by chemigation, soil injection or soil bedding equipment as is known in the art. Application is typically at depths of 8 inches to 18 inches below the surface of the ground. When injected, the soil is sometimes covered with plastic to prevent volatilization of the fumigant. Depending upon the chemical, rate, and environmental conditions at time of application, reductions in soil populations have ranged from 85-95%. Fumigation rates need to be high when soil populations of Verticillium are large or when populations need to be reduced for many years, for example with orchards and certain nut trees.

As various fumigants have been increasingly restricted due to outgassing and deleterious effects with ozone, other fumigants such as 1,3-dichloropropene (1,3-D), chloropicrin (CP) and methyl isothiocyanate (MITC) generators (like metam sodium or dazomet and metam potassium) have seen increasing use. In addition to direct toxicity, some fumigants are also regulated as volatile organic compounds. The purpose of fumigation is to achieve maximum control of soilborne pests, which requires an effective concentration or exposure duration and the uniform distribution of fumigants in soil. Soil fumigants, such as dithiocarbamates, including especially sodium methyldithiocarbamate (metam sodium) and potassium N-methyldithiocarbamate (metam potassium), are routinely used by growers to control various pests including Verticillium dahliae. There is a custom of calling sodium salts of metam “metam sodium” but the custom is not as prevalent for the potassium salts. As used herein, metam sodium is synonymous with sodium metam, and so on for other salts.

Liquid metam sodium is typically sold commercially as about a 42% by weight aqueous solution, having about 4.25 pounds active ingredient per gallon (505 g/L), though the concentration can vary depending on manufacturer. Liquid potassium metam is commercially available at higher concentrations, nearly 54% or 56% by weight solution. Combination formulations are available, generally containing between 42% and 56% by weight of mixed alkali salts of metam. While it is of course possible to use more dilute product, use of concentrated product is preferred so long as the product is stable and can be dispersed into soil using standard existing equipment.

Current fumigation application techniques include broadcast fumigation and chemigation. With standard broadcast fumigation, fumigants are applied directly to the soil at a certain depth using conventional equipment or rigs (shanks). Fumigants must be added below the soil surface, that is, injectors must be placed below the soil surface before product flow begins. Chemigation is injecting fumigants into soil with irrigation water through nozzles or drip tapes. These injected solutions typically are dilute so that movement of water away from injection nozzles moves the fumigant through the soil. Generally, dilution (with for instance irrigation water) is in the range of between 500 gallons of water to one gallon of liquid metam to about 10000 gallons of water to one gallon of liquid metam, more typically between 1000 gallons of water to one gallon of liquid metam to about 5000 gallons of water to one gallon of liquid metam, often about 2000 gallons of water to one gallon of liquid metam to about 4000 gallons of water to one gallon of liquid metam.

Metam is a commonly used fumigant. Metam is rapidly converted to MITC in soil, and MITC is volatile, readily evaporates and does not pose groundwater concerns. Metam's primary use is for soilborne disease suppression in potatoes, carrots, onions, tomatoes and other crops. A side benefit is some weed control, because metam or its reaction products are toxic when applied. A typical treatment rate for soils facing significant disease pressure is about 40 gallons of metam sodium per acre (190 Kg of active ingredient/ha). At commercial conditions this treatment will reduce certain soilborne disease by ˜70%. In calcareous soils and in certain other soil types, efficacy tends to be lower. High calcareous areas include parts of California, Florida, Idaho, Washington and Nevada. Areas high in clay content and high disease pressure include North Dakota. Secondary uses are nematode and weed suppression. Ground applications favor nematode suppression while chemigation favors disease suppression, primarily due to the location of the pests.

Issues with organic fumigants are many. Most fumigants carry “harmful if exposed” terminology of their label. Exposure can occur during application or even after application as fumigant leaves the soil. Outgassing to atmosphere is a health concern and also results in fumigant loss. There are numerous methods to try to keep fumigant in the soil for a few days, including using tarps, overwatering to form water barriers, and the like. Additionally, before application of fumigant, the soil must be shown to have sufficient moisture. Use of fumigants can be expensive, in part because of high use rates required in certain areas. For example, 42% metam is labeled for use rates up to 75 gallons per acre (701.6 l/ha). Further, use of certain fumigants is not permitted in organically labeled produce. Dispersion and mixing into soil is difficult. Finally, the efficacy of fumigants is reduced in certain soil-types, and certain materials in certain soils can degrade or deactivate a portion of the fumigant. For example, certain classes of fumigants, including metam, are less effective against pests in highly calcareous soil.

To reduce emission of fumigants from soil, overwatering is typically used. Chemicals have been used in the overwatering to help further reduce emissions. Halogenated fumigants are among the most heavily used pesticides in agriculture. Because of their high mobility and toxicological characteristics, the contamination of air or groundwater by certain of these compounds has been a great environmental concern. Reaction of such fumigants with polysulfides was found to result in rapid dehalogenation of several halogenated fumigants. For example, the reaction of polysulfides and methyl iodide (MeI), 1,3-dichloropropene (1,3-D), and chloropicrin (CP) was very rapid. Given the high reactivity of polysulfide salts toward those certain halogenated fumigants, this reaction is used as a pollution mitigation strategy, such as for disposal of fumigant wastes, treatment of fumigant-containing wastewater, and cleanup of fumigant residues in environmental media. In “Methods evaluated to minimize emissions from preplant soil fumigation,” S. Gao, et al., California Agriculture 65(1):41-46, January-March 2011, the authors suggested overwatering with water and chemicals. Similarly, sodium thiosulfate is highly reactive to methyl bromide. Generally, for bare-soil fumigation, emissions from subsurface drip application are lower than broadcast-shank injections. This is attributed to increasing soil water content decreases vapor diffusion and increases the amount of fumigant partitioning in the aqueous phase, and there are no shank traces (i.e., soil fractures) that can serve as volatilization channels. But substantially higher soil water content would reduce the fumigant's distribution in soils by reducing vapor diffusion, reducing efficacy. Good efficacy can only be ensured when the fumigant moves with applied water for a relatively uniform distribution. U.S. Published Application No. 20080214398 relates to using sodium azide in soil as a sterilizing agent. A problem with sodium azide is that it persists, and growers must wait for as much as several weeks after treatment before planting. U.S. Published Application No. 20080214398 teaches deactivating sodium azide by applying a deactivating compound, preferably a sulfur containing compound selected from the group consisting of a dithiocarbamate, a thiocarbamate, a carbamate, an organic sulfide, an organic disulfide, an aldehyde, and mixtures of these compounds. The deactivating compound is preferably applied to soil at a rate of 1 to 500 lbs/acre. The amount of deactivating compound applied to soil is sufficient to react with the sodium azide to effectively inactivate the sodium azide.

Soil amendments with chemicals such as ammonium or potassium thiosulfate, thiourea or certain polysulfides sprayed over soil surface are effective in reducing emissions with certain types of fumigants. These chemicals, which are sprayed or dripped in very low concentrations, less than 1% and typically less than 0.2% by weight, can react with fumigants to form nonvolatile compounds by dehalogenation. This would, of course, deactivate the fumigant. “Dechlorination of Chloropicrin and 1,3-Dichloropropene by Hydrogen Sulfide Species: Redox and Nucleophilic Substitution Reactions,” W. Zheng et al., J. Agric. Food Chem., 2006, 54 (6), pp 2280-2287, stated that chlorinated fumigants chloropicrin (trichloronitrome thane) and 1,3-dichloropropene (1,3-D) react rapidly with hydrogen sulfide species (H2S and HS—).

Irrigation with sprinklers forms a water seal, which minimizes emissions after fumigation. A high water content in the surface soil has been shown to provide an effective barrier to 1,3-D movement. Intermittent water seals following soil fumigation have been effective in reducing emissions of MITC. When irrigation stops, however, the emission flux tends to increase, depending on fumigant concentrations in the soil. As a result, cumulative or total emission losses may not be reduced as substantially as the peak flux. Reducing the peak flux is important because it lowers the potential exposure risk to workers and bystanders. Buffer zones are determined based on the peak emission flux. More frequent water applications are more efficient in reducing emissions than fewer applications with large amounts of water. But the high water content in surface soil can reduce the efficacy of a fumigant to control nematodes near the surface and to control weeds.

U.S. Pat. No. 7666309 describes using diluted calcium polysulfide in irrigation drips. The patent relates only to dilute solutions, where the polysulfide content is 1% or less. The patent states that calcium precipitation in irrigation equipment, especially in nozzles, results in plugging. This patent suggested adding an alkali sulfide as a precipitation preventing compound to the water to reduce precipitation. The sodium methyldithiocarbamate can be injected into an irrigation water stream after injection of the precipitation preventing compound, either before or after injection of calcium polysulfide, to prevent precipitation of the sodium methyldithiocarbamate. Alternatively, the sodium methyldithiocarbamate can be added to an aqueous solution of calcium polysulfide containing an effective amount of the precipitation preventing compound.

Applicant had previously filed pending U.S. application Ser. No. 15/683,601 titled METAM SALTS AND POLYSULFIDE SOIL TREATMENT, the contents of which are incorporated herein by reference thereto as may be allowed by law. Lime sulfur (a mixture of calcium polysulfides) will kill certain fungi and insects when applied to apple trees. Spraying a dilute aqueous solution in an orchard is fairly common. Labels warn not to apply more than 30 gallons of this product/acre/year to any crop listed on this label. See, for example, the NovaSource® Lime-Sulfur Solution™ Agricultural Fungicide. Lime Sulfur Solution™ (LSS, or “liquid lime sulfur”) is a calcium polysulfide-based solution available from Tessenderlo Kerley Inc. and is currently registered to control powdery mildew in grapes, and is labeled in many States as a tool for apple blossom thinning Large quantities of liquid lime sulfur are known to be applied to established trees as a foliar spray. Such sprays are applied in a manner to minimize the amount reaching the ground. Lime sulfur is also known as a soil additive useful as an acidifying agent. Applied to soil, CPS (calcium polysulfide) is also known to buffer soil pH, enhance sulfur fertilization and optimize nitrogen utilization of crops. A commercial product is SOLMENDA™ available from Tessenderlo Kerley. Application rates are: for alkaline soil correction and improvement of water penetration, 10 gallons of SOLMENDA™ per acre in irrigation water on growing plants; for preplanting treatment, use 20 to 30 gallons of SOLMENDA™ per acre in irrigation water; and for preplanting treatment of soil, use ½ to ¾ gallons of SOLMENDA™ per 1,000 square feet in irrigation water. 30 gallons per acre of this product is equivalent to 90 pounds of calcium polysulfide per acre (101 Kg calcium polysulfide/ha).

Three fourths of a gallon per 1000 square feet of this product is equivalent to 32 pounds of calcium polysulfide per acre (37 Kg calcium polysulfide/ha). SOLMENDA™ is labeled to condition soil, and is limited to between 20 and 30 gallons per acre in preplant. This is 60 to 90 pounds of calcium sulfide per acre.

Liquid ammonia (ammonium) polysulfide was available as APS-600™ from Tessenderlo Kerley Inc. at an approximately 60% by weight solution, where the label says to apply in irrigation water or that APS-600 when diluted with water to 15% or lower nitrogen assay may be applied to soil. Application rates are 10 to 15 gallons per acre. This formulation contains 3.76 pounds of sulfur (in polysulfide) and 1.88 pounds of ammoniacal nitrogen per gallon. Nitro-Sul™ ammonium polysulfide solution available from Tessenderlo Kerley states the maximum annual application rate is 60 gal/acre.

### SUMMARY OF THE INVENTION

An aspect of the invention relates to a method of treating disease in arable soil prior to crop planting, comprising: applying to the surface or subsurface of the arable soil a stable aqueous solution comprising an MITC-generating fumigant and one or more of: calcium thiosulfate, calcium chloride and/or calcium nitrate prior to planting, wherein the amount of calcium thiosulfate, calcium chloride and/or calcium nitrate added is at least about 137 kg/ha. Preferably the aqueous solution is of the invention is applied below the soil surface.

The aqueous solutions of the invention are preferably used in the form of a concentrated solution, or possibly as a slightly diluted solution (due to mix with ground water) to have an optimal efficiency. Concentrated solutions are preferred. It was found that the combination of the one or more of calcium thiosulfate, calcium chloride and/or calcium nitrate blend well with common pest control agents like soil fungicides, soil insecticide and/or soil fumigants, more in particular soil insecticides and/or soil fumigants, most in particular soil fumigants like a metam salt. Aqueous solutions of the invention proved to be stable and to have a long shelf life as documented further.

An aspect of the invention relates to a stable concentrated liquid solution, said stable concentrated liquid solution comprising:
a. between about 4% and about 30% total by weight of calcium thiosulfate, calcium chloride and/or calcium nitrate;
b. at least about 2% by weight of a soil fungicide, insecticide and/or fumigant; and
c. water.

Preferably the stable concentrated liquid solution of the invention comprises between about 4% and about 30% total by weight of calcium thiosulfate, calcium chloride and/or calcium nitrate; and between about 4% and about 54% by weight of a soil fumigant, said fumigant comprising a dithiocarbamate. Preferably the dithiocarbamate comprises N-methyldithiocarbamate, and preferably the weight ratio of the fumigant(s) to the calcium thiosulfate, calcium chloride and/or calcium nitrate is between about 10:1 and about 1:10.

In a preferred embodiment of the invention a salt of dithiocarbamate is used that preferably is selected from alkali salts such as a sodium salt of N-methyldithiocarbamate and/or a potassium salt of N-methyldithiocarbamate. Other useful compounds are listed herein in this specification.

Particularly preferred in the invention is a stable concentrated liquid solution as claimed, wherein the dithiocarbamate comprises, alternatively is, an alkali salt of N-methyldithiocarbamate, and wherein the weight ratio of the salt of the methyldithiocarbamate to the calcium thiosulfate, calcium chloride and/or calcium nitrate is between about 10:1 to about 1:10.

In any of the above, the fumigant used preferably comprises a salt of metam, and preferably the concentration of (1) the salt of metam and the concentration of (2) the calcium thiosulfate, calcium chloride and/or calcium nitrate in the concentrated solution of the invention are each greater than about 5% by weight.

Another aspect of the invention relates to a method of treating soil pathogens, said method comprising treating a soil with the stable concentrated solution of the invention, which could be any of the above described stable concentrated solutions. In a preferred embodiment, at least a portion of the concentrated liquid solution is placed at a depth 4 inches subsurface or below. More information on how to apply, how frequent to apply, and at what depths to apply are provided herein.

Still another aspect of the invention relates to a stable concentrated liquid solution, said stable concentrated liquid solution comprising,
a. between 4% and about 50% total by weight of calcium thiosulfate, calcium chloride, and/or calcium nitrate;
b. between 4% and about 56% by weight of a fumigant, said fumigant comprising a salt of methydithiocarbamate or other MITC generator; and
c. water.

### DETAILED DESCRIPTION OF THE INVENTION

In one embodiment the invention is a stable concentrated solution of a dithiocarbamate fumigant and an inorganic compound, said inorganic compound comprising, consisting essentially of, or alternatively consisting of at least one of calcium thiosulfate, calcium chloride, calcium nitrate, or any mixtures thereof By “stable” is meant that there is no phase separation under standard conditions and that the ingredients mix well. Stability over time and shelf life are further documented herein. Said fumigant preferably is a dithiocarbamate fumigant, preferably a metam salt. The concentrated solution used in the invention in general comprises at least about 2% by weight calcium thiosulfate, calcium chloride, calcium nitrate, or any mixture thereof, and at least about 0.5% by weight of fumigant, which may be an alkali salt of a fumigant, more preferably greater than about 5% by weight of calcium thiosulfate, calcium chloride and/or calcium nitrate and greater than about 2% by weight of the fumigant, for example wherein each of the dithiocarbamate fumigant and the (total of) calcium thiosulfate, calcium chloride and/or calcium nitrate is present in the concentrated solution in an amount 3% by weight or greater, 4% by weight or greater, 6% by weight or greater, or 10% by weight or greater. In one embodiment, the solution can additionally comprise calcium polysulfide in an amount up to about 60% of the weight of the calcium thiosulfate, calcium chloride, calcium nitrate or any mixture thereof. In one embodiment the solution is free of or is substantially free of calcium polysulfide, for example containing calcium polysulfide in an amount less than about 20% of the weight of the calcium thiosulfate, calcium chloride, calcium nitrate or any mixture thereof The dithiocarbamate is preferably a salt of methyldithiocarbamate, for example an alkali salt. Examples thereof are metam sodium (sodium N-methyldithiocarbamate), metam potassium (potassium N-methyldithiocarbamate) and/or metam ammonium (ammonium N-methyldithiocarbamate). In particular metam sodium and/or metam potassium are preferred. In concentrated solutions, as described herein, metam is not reactive to calcium thiosulfate, calcium chloride and/or calcium nitrate, such that less than 5% of the dithiocarbamate, and less than 5% of the calcium thiosulfate, calcium chloride, calcium nitrate or any mixture thereof is lost to reaction or precipitation during normal storage, that is, over about 8 months' time period at warehouse conditions, preferably in a closed container. Further, the combination of fumigant and calcium thiosulfate, calcium chloride and/or calcium nitrate aids both penetration of the fumigant into soil and suppresses adverse reactions between certain soil types and the fumigants. The invention also relates to treating soil pathogens (fungi, bacteria, and nematodes) with the concentrated solution, advantageously comprising or consisting essentially of a fumigant and an inorganic compound being calcium thiosulfate, calcium chloride and/or calcium nitrate, and said dithiocarbamate preferably comprising or consisting essentially of an alkali salt of methyldithiocarbamate. It is believed that the high concentration of said inorganic compounds, results in lower rates of degradation, increased soil adsorption or retention, and improved distribution of metam or methyl isothiocyanate (MITC) in the soil. In one embodiment of the invention the soil pathogen is a fungus. In another embodiment of the invention the soil pathogens are bacteria. In yet another embodiment of the invention the soil pathogen treated is a nematode. In yet another embodiment of the invention the soil pathogen is an insect. The method of the invention is in particular useful for the treatment of fungi.

The invention is believed to be useful with a number of other fumigants and soil insecticides/pesticides, including those fumigants disclosed in WO 1997000857, allyl isothiocyanate, Oxamyl [Methyl N′N′-dimethyl-N-[(methylcarbamoyl)oxy]-1-thiooxamimidate], penthiopyrad, fluopyram N-[2-[3-chloro-5-(trifluoromethyl)-2-pyridinyl]ethyl]-2-(trifluoromethyl)benzamide with or without imidacloprid, methyl bromide (when used with the soluble calcium chlorides and/or nitrates), ethanedinitrile, fluensulfone: 5-chloro-2 (3,4,4-trifluoro-but-3-ene-1-sulfonyl)-thiazole, dimethyl disulfide, and calcium phosphide. These can be used together with the concentrate of the invention (e.g. be provided as a separate solution) and/or they can be added to the concentrate of the invention. The invention may further be useful with 1,3-dichloropropene and chloropicrin if the fumigant is stabilized. Advantageously, and preferably, the soil has not been treated, at least within the past month or preferably within the last two months, with a sterilant such as sodium azide.

The invention also relates to treating soil for soil pathogens, including fungi, bacteria, and nematodes, for example the lists of diseases that can be found on the label for metam, said soil to be used to grow vegetables, especially root, tuber and bulb vegetables, but also including leafy vegetables, cucurbits, and fruiting vegetables, and small fruit such as strawberries, or tomatoes, that are susceptible to Verticillium wilt and other listed diseases, including for example Pythium on carrots. Other examples of susceptible crops include cabbage, celery, cucumber, eggplant, lettuce, melons, pepper, potato, pumpkin, radish, rhubarb, peanut, and tomato. Treating is accomplished by applying to the subsurface of the soil the concentrated solutions described above and herein, and/or by applying a slightly diluted solution of this invention. By slightly diluted we mean for example diluting the concentrate by a factor of for example 10:1 with water, or for example diluting but keeping calcium thiosulfate, calcium chloride and/or calcium nitrate concentrations above about 1%. The treatment is most beneficial when the concentration of the calcium thiosulfate, calcium chloride and/or calcium nitrate solution contacting pests is high, for example greater than 1%, more typically greater than 2%, for example greater than 3%, 4% or 5% by weight. These values include dilution by moisture in soil. Said treatment is especially beneficial for treating soil used for growing root and bulb vegetables and especially potatoes, as well as tomatoes, berries and small fruit as well as fruiting vegetables, wherein the treatment is applied before the vegetables or fruits are planted, or simultaneous with planting if seeds are not subject to phytotoxic effect from the treatment of the fumigant calcium thiosulfate, calcium chloride and/or calcium nitrate. Preferred treatment time is pre-planting, before crops or seeds are put into the soil.

In another embodiment of the invention, a stable concentrated pre-mix solution as described in the paragraphs above is used to treat arable soil, wherein the solution is added to irrigation water or in a holding vessel with water at low dosage, that is, less than about 1% by weight of calcium thiosulfate, calcium chloride and/or calcium nitrate in the treatment water. The alkalinity in the metam, typically present as alkali hydroxides, will typically buffer the irrigation water solution and prevent precipitation (blooming) provided the carbonate concentration in the water is low. Advantageously and preferably, the solution thus prepared is free from added alkali sulfides, which are an immediate health concern.

As used herein, when an application rate of metam sodium is expressed as gallons per acre, it is understood that a gallon contains 4.25 pounds of sodium methyldithiocarbamate per gallon, and one gal./acre sodium metam solution such as Sectagon®-42 is equivalent to 4.76 kg/ha of metam sodium. As used herein, when an application rate of potassium metam is expressed as gallons per acre, it is understood that a gallon contains 5.63 pounds of potassium methyldithiocarbamate per gallon, and one gal./acre potassium metam solution such as Sectagon®-54 is equivalent to 6.3 kg/ha of potassium methyldithiocarbamate. Various fumigants are used at different rates and have different molecular weights, but it is well within the skill of the practitioner to adjust weights of the fumigant to account for these issues.

In preferred embodiments of the invention, the calcium thiosulfate, calcium chloride and/or calcium nitrate and the salt of metam are applied as a single mixed solution, to ensure that the benefits of the mixture are achieved. Applying as two separate mixtures runs a risk of having insufficient mixing and distribution, resulting in volumes of soil that are deficient is one ingredient or the other, which would suppress several advantages of the invention. Advantageously the calcium thiosulfate, calcium chloride and/or calcium nitrate is preferably primarily calcium thiosulfate, for example wherein the amount by weight of calcium thiosulfate is greater than or equal to the total amount of any calcium chloride and/or calcium nitrate present. In a particular embodiment of the invention, the inorganic calcium-containing compounds used comprise at least one calcium thiosulfate. In another particular embodiment of the invention, the inorganic calcium-containing compound is selected from thiosulfates.

Another aspect of the invention is a stable concentrated pre-mix solution of calcium thiosulfate, calcium chloride and/or calcium nitrate, optionally but preferably additionally comprising minor amounts of liquid lime sulfur (aqueous calcium polysulfide, CAS No 1344-81-6), and a polysulfide-stable fumigant or fumigants, including for example methyl isothiocyanate (MITC) generating fumigants, preferably a metam, wherein said solution is shelf stable and can be applied to the subsurface of soil using existing equipment used in the art. By shelf stable we mean the solution is stable over a season, that is, less than about 5%, preferably less than about 3%, more preferably less than about 0.5% by weight of the fumigant and each of the calcium thiosulfate, calcium chloride and/or calcium nitrate present is lost when stored at ambient conditions in a closed container over an 8 month period of time. Advantageously the weight ratio of the salt of metam to the inorganic calcium compounds range from 20:1 to 1:20, for example between 10:1 and 1:10, or 4:1 and 1:4, or between 2:1 and 1:2, or between 3:1 and 1:3, or other ranges using the above range endpoints, such as for example 2:1 to 1:10. Preferred weight ratios are about 1 part calcium thiosulfate to between about 0.3 to 5 parts fumigant. Advantageously the polysulfides, if present, are primarily calcium polysulfides. Advantageously the methyl isothiocyanate (MITC) generating fumigants comprises, consists essentially, or alternatively consists of metam sodium, potassium metam, or a mixture thereof.The solution can optionally contain added stabilizers, antifreeze agents, wetting agents, and penetrating agents.

The invention relates to a stable concentrated solution of a dithiocarbamate fumigant, preferably comprising or consisting essentially of an MITC generator, and calcium thiosulfate, calcium chloride and/or calcium nitrate, wherein the concentrated solution comprises at least 2% by weight calcium thiosulfate, calcium chloride and/or calcium nitrate and at least 0.5% of an alkali salt or salts of a dithiocarbamate fumigant, more preferably greater than 5% by weight of calcium thiosulfate, calcium chloride and/or calcium nitrate and greater than 2% by weight of the dithiocarbamate, for example wherein each of the dithiocarbamate fumigant and calcium thiosulfate, calcium chloride and/or calcium nitrate is present in the concentrated solution in an amount 4% by weight or greater. The preferred concentration of the solution of calcium thiosulfate, calcium chloride and/or calcium nitrate and salts of metam (sodium or potassium), called collectively “active ingredients” here, are at least 2 pounds of active ingredients per gallon (240 g/L), more preferably at least 2.5 pounds of active ingredients per gallon (300 g/L), more preferably at least 2.75 pounds of active ingredients per gallon (330 g/L). A practical maximum is about 5 pounds of active ingredients per gallon (less than 600 g/L).

The dithiocarbamate is preferably an alkaline salt of methyldithiocarbamate. Alkaline earth or ammonium methyldithiocarbamate, for example calcium salt, can also be used, though it is not preferred. Advantageously in one embodiment the treating solution comprises or consists essentially of at least 2% by weight calcium thiosulfate, calcium chloride and/or calcium nitrate, and at least 0.5% of a salt of a dithiocarbamate fumigant. More preferably the treating solution comprises greater than 5% by weight of calcium thiosulfate, calcium chloride and/or calcium nitrate or any mixture thereof and greater than 2% by weight of the fumigant. In one aspect the fumigant is a salt of metam, and the concentration of the salt of metam and the concentration of the calcium thiosulfate, calcium chloride and/or calcium nitrate, in the concentrated solution are each greater than about 5% by weight, for example greater than 8% by weight, or alternatively greater than 12% by weight. The concentrated solution is used to treat arable soil to inhibit soil pathogens. It is believed that the high concentrations of the compounds, that is, the high concentration of lime sulfur admixed with a metam, results in lower rates of degradation, increased soil penetration and retention, and improved distribution of metam or methyl isothiocyanate (MITC) in the soil.

Another aspect of the invention is a stable concentrated pre-mix solution of calcium thiosulfate, calcium chloride and/or calcium nitrate, and a metam, wherein said solution is shelf stable and can be applied to the subsurface of soil using existing equipment used in the art. Advantageously the concentration of the salt of metam and the concentration of at least one of calcium thiosulfate, calcium chloride and/or calcium nitrate, or any mixture thereof, are each greater than 3% by weight or greater than 5% by weight, for example greater than 8% by weight, and in most preferred cases greater than 12% by weight. Advantageously the weight ratio of the salt of metam to the calcium thiosulfate, calcium chloride and/or calcium nitrate range from 20:1 to 1:20, for example between 10:1 and 1:10, or 4:1 and 1:4, or between 2:1 and 1:2, or other ranges using the above range endpoints, such as for example 2:1 to 1:10. The amount of calcium thiosulfate, calcium chloride and/or calcium nitrate in a concentrated solution of fumigant can vary, with less calcium thiosulfate, calcium chloride and/or calcium nitrate needed when treating soils not containing large amounts of alkaline deposits and clays. A useful concentration can be as little as 4% by weight calcium thiosulfate, calcium chloride and/or calcium nitrate in a solution of 30% or more of a salt of metam can improve the performance of the metam.

The invention also relates to stable concentrated solutions of calcium thiosulfate, calcium chloride and/or calcium nitrate and MITC-generating fumigants. The invention also relates to treating soil for soil pathogens, including fungi, bacteria, and nematodes, by applying to the subsurface of the soil the concentrated or diluted premixed formulations of this invention.

In another embodiment of the invention, a stable concentrated pre-mix solution as described in the paragraphs above is used to treat arable soil, wherein the solution is added to irrigation water or in a holding vessel with water at low dosage, that is, less than about 2% by weight of calcium thiosulfate, calcium chloride and/or calcium nitrate in the treatment water. The alkalinity in the metam, typically present as alkali hydroxides, will buffer the irrigation water solution and prevent precipitation. Advantageously the solution is free from added alkali sulfides, which are an immediate health concern.

Advantageously the concentration of the (total of) calcium thiosulfate, calcium chloride and/or calcium nitrate is greater than 2% by weight, alternatively greater than 5% by weight, for example greater than 8% by weight, and in most preferred cases greater than 12% by weight. Said stable calcium thiosulfate, calcium chloride and/or calcium nitrate is added to the subsurface of the soil, and applying includes mechanically disturbing the soil so as to assist movement of the calcium thiosulfate, calcium chloride and/or calcium nitrate solution through the soil, where the treatment rate is at least 100 pounds per acre (121 Kg/ha), preferably at least 127 Kg/ha, more advantageously at least 150 pounds per acre (181 Kg/ha), for example between 200 pounds per acre (242 Kg/ha) and 400 pounds (484 Kg/ha) or to 600 pounds (726 Kg/ha) or 800 pounds per acre (987 Kg/ha). Alternatively the treatment rates are for the calcium thiosulfate, calcium chloride and/or calcium nitrate per acre a rate of at least 138 pounds per acre, more preferably at least 153 pounds per acre, for example at least 184 pounds per acre, or at least 246 pounds per acre, for example at least 307 pounds per acre.

A exemplary formulation is a stable concentrated solution that comprises water, about 10% by weight or greater of a salt of metam, about 10% by weight or greater of calcium thiosulfate, calcium chloride, calcium nitrate, or any mixture of two or more of the above, optionally up to about 10% by weight calcium polysulfide, and optionally between 0.01 and 5% auxiliaries such as pH buffers, surfactants, antioxidants, antimicrobials, antifreeze, and other common adjuvants, with the balance being water.

An example is a stable concentrated liquid solution, said stable concentrated liquid solution comprising between 2% and about 30% of calcium thiosulfate, calcium chloride and/or calcium nitrate; between 2% and about 54% of a soil fumigant, said fumigant comprising a salt of a dithiocarbamate; and water. Concentrated solutions are preferred, so another example comprises between 4% and about 30% of calcium thiosulfate, calcium chloride and/or calcium nitrate; between 4% and about 54% of a soil fumigant, said fumigant comprising a salt of a dithiocarbamate; and water. Percentages are herein percentages by weight, relative to the total weight of the composition. Generally, when we state “dithiocarbamate” we include alkyl-substituted versions thereof including N-methyldithiocarbamate, which is the preferred fumigant. The stable concentrated liquid solution contains both the fumigant and the calcium thiosulfate, calcium chloride and/or calcium nitrate. For the exemplary solution where the dithiocarbamate is methyldithiocarbamate, and the inorganic calcium compound is calcium thiosulfate, the weight ratio of the salt of the methyldithiocarbamate to the calcium thiosulfate is generally between about 10:1 to about 1:10, for example between 1:9 to 9:1, or alternatively between about 5:1 to 1:5. The commercial blends may have a weight ratio of inorganic thiosulfate (preferably comprising or consisting essentially of calcium thiosulfate) to fumigant (preferably an MITC-generating fumigant) of between 4:1 to about 1:15.

All weights are percent by weight of the solution unless otherwise stated. Calcium salts means soluble calcium salts, that is, calcium nitrate or calcium chloride. Weight percent of salts of metam includes the alkali metal counter ion.

A stable concentrated liquid solution can be formulated, said stable concentrated liquid solution comprising between 4% and about 30% of calcium thiosulfate, calcium chloride and/or calcium nitrate, between 4% and about 56% of a soil fumigant, said fumigant comprising a salt of a metam. Percentages are herein percentages by weight, relative to the total weight of the composition. In certain conditions, the preferred concentrated solution contains between 10% and 50% by weight, for example between 15% and 40% by weight, of the total of the dithiocarbamate salts and calcium thiosulfate, calcium chloride and/or calcium nitrate. The solution is preferably free of alkali sulfides. The weight ratio of calcium thiosulfate, calcium chloride and/or calcium nitrate to alkali metam is between about 15:1 to about 1:15, or between about 10 to 1 to about 1:10, for example between about 4:1 to 1:4, or between 2:1 to 1:2, or any ratio using the above listed boundaries in any combination.

The invention also relates to treating soil pathogens with the concentrated solution, advantageously comprising or consisting essentially of a dithiocarbamate fumigant and calcium thiosulfate, calcium chloride and/or calcium nitrate, and a fumigant that is stable in a concentrated solution of the calcium thiosulfate, calcium chloride and/or calcium nitrate, preferably the fumigant comprising a dithiocarbamate, more preferably comprising or consisting essentially of an alkali salt of methyldithiocarbamate. Advantageously, the treatment is applied below the surface of the soil, particularly at a depth of about 2 inches or more below the surface of the soil, for example below 4 inches below the surface of the soil. Often treatment is applied at more than one depth, for example at 4 inches depth and at 8 inches depth. Advantageously in one embodiment the treating solution comprises or consists essentially of at least 2% by weight calcium thiosulfate, calcium chloride and/or calcium nitrate, and at least 0.5% of a salt of a dithiocarbamate fumigant. In another embodiment the treating solution comprises greater than 5% by weight of calcium thiosulfate, calcium chloride and/or calcium nitrate and greater than 2% by weight of the dithiocarbamate. In one aspect the fumigant is a salt of metam, and the concentration of the salt of metam and the concentration of the calcium thiosulfate, calcium chloride and/or calcium nitrate, in the concentrated solution are each greater than about 5% by weight, for example greater than 8% by weight, or alternatively greater than 12% by weight. It is believed that the high concentrations of the compounds, that is, the high concentration of calcium thiosulfate, calcium chloride and/or calcium nitrate admixed with a dithiocarbamate fumigant, preferably calcium thiosulfate, calcium chloride and/or calcium nitrate admixed with a metam, results in more uniform effectiveness of metam, possibly due to lower rates of degradation by adverse soil conditions, increased soil retention, or improved distribution of the metam or methyl isothiocyanate (MITC) in soil.

While treating with a pre-mix is desired, the invention in a different embodiment also includes treating soil with tank mix or in a flowing pipe mix, where said mix includes both the MITC-generating fumigant, for example a salt of metam, and calcium thiosulfate, calcium chloride and/or calcium nitrate, wherein the mix comprises more than 1%, for example more than 2% by weight of the calcium thiosulfate, calcium chloride and/or calcium nitrate, or wherein the applied amount is sufficient to add more than about 100 pounds per acre of the calcium thiosulfate, calcium chloride and/or calcium nitrate, along with the MITC-generating fumigant.

In another embodiment a stable concentrated liquid solution can be formulated, said stable concentrated liquid solution comprising between 4% and about 50% of calcium thiosulfate, calcium chloride and/or calcium nitrate, between 4% and about 56% of a soil fumigant, said fumigant comprising or consisting essentially of an MITC-generating compound, or a salt of a dithiocarbamate, preferably methyldithiocarbamate or salt thereof; and water. In most preferred conditions, the concentrated solution contains between 10% and 50% by weight total of the dithiocarbamate salts and calcium thiosulfate, calcium chloride and/or calcium nitrate. Percentages are herein percentages by weight, relative to the total weight of the composition. The solution is preferably free of alkali sulfides. However, the solution can contain alkali hydroxides, surfactants, and other adjuvants. The weight ratio of calcium thiosulfate, calcium chloride and/or calcium nitrate to fumigant depends on the atomic weight of the calcium thiosulfate, calcium chloride and/or calcium nitrate and the salt of fumigant selected.

In another embodiment the mole ratio of calcium thiosulfate, calcium chloride and/or calcium nitrate to fumigant, said fumigant being selected from one or more of a sodium metam, potassium metam, other MITC generator, or combinations thereof, is between about 15:1 to about 1:15, or about 10:1 to about 1:10, or alternatively about 8:1 to 1:8, for example between about 4:1 to 1:4, or between 2:1 to 1:2, or any ratio using the above listed boundaries in any combination.

In another embodiment of the invention, a concentrated solution as described above is used to treat soil. It can be important to use concentrated liquids for application subsurface using a shank or other such mechanical device. The growers do not have the capacity to haul large tanks of diluted compositions in these operations. Metam as either sodium or potassium salts are typically sold in concentrations greater than 20% by weight, for example between 25% and 45% by weight for sodium metam (also called metam sodium), or between 35% and 42% by weight for potassium metam. For potassium metam, the concentration is even greater, say between 20% and 70%, for example between 35% and 65%, often nearer 60% by weight for some commercial products. As some of the mixtures of the present invention can be made by simply admixing commercially available metam and calcium thiosulfate, calcium chloride and/or calcium nitrate compositions, say in a ratio between 1:20 to 20:1, the resulting compositions will typically have less of both the fumigant and of the calcium thiosulfate, calcium chloride and/or calcium nitrate than the formulations from which it was made. This is not always the case, however, as more concentrated products than are routinely marketed can be used to formulate the pre-mix of fumigant and calcium thiosulfate, calcium chloride and/or calcium nitrate.

In a preferred embodiment of the invention, a highly concentrated stable solution of an alkali salt of metam and of calcium thiosulfate, calcium chloride and/or calcium nitrate are injected into the soil in ground that will be used for planting tomatoes, vegetables and small fruit including tomatoes, strawberries, or other crops. In most preferred embodiments, the solution contains more than 2%, preferably more than 4%, and typically more than 6% or more than 8% total of the fumigant(s), for example a sodium and/or potassium salt of a dithiocarbamate fumigant such as metam, and of the calcium thiosulfate, calcium chloride and/or calcium nitrate.

In another embodiment of the invention, a concentrated solution as described in the paragraphs above is used to treat soil, wherein the above solution is added to irrigation water at low dosage, that is, less than about 2% by weight or less than about 1% by weight of calcium thiosulfate, calcium chloride and/or calcium nitrate in the treatment water, said solution further comprising a salt of metam and an alkali hydroxide.

Dilute liquid lime sulfur or calcium polysulfide (CPS) going through the sprinklers may eventually result in precipitation and nozzle clogging. Similar problems exist with calcium nitrate and calcium chloride forming precipitates if added water has alkalinity (carbonates). Calcium thiosulfate may also bloom. The solutions of the invention are therefore advantageously slightly basic, typically the result of added alkali hydroxides, to buffer the irrigation water solution and prevent precipitation during injection. Potassium hydroxide is preferred. Based on laboratory testing, we determined that KOH at less than 1%, for example between about 0.1% to 1%, or between 0.2% to 0.5%, by weight, will prevent precipitation of diluted calcium thiosulfate, calcium chloride and/or calcium nitrate solutions in water. Advantageously the alkali hydroxide is added to the dilution water before or at the same time as the calcium thiosulfate, calcium chloride and/or calcium nitrate. During chemigation, a typical dilution would be the number of gallons of treatment, say for example 80 gallons of a 1:1 mixture of a metam solution (40% or 42% for metam sodium, or ˜52% to 54% for potassium metam), and a liquid calcium thiosulfate, calcium chloride and/or calcium nitrate solution (29%). For chemigation, this solution may be diluted in 14000 gallons of water, providing about 0.5 inches of treated water.

Without being bound by theory, we believe that when concentrated solutions of calcium thiosulfate, calcium chloride and/or calcium nitrate and dithiocarbamate are used to treat the subsurface of the soil, especially those comprising or consisting essentially of concentrated calcium thiosulfate, calcium chloride and/or calcium nitrate and an alkali salt of metam, the reactions between the calcium thiosulfate, calcium chloride and/or calcium nitrate and the soil slow the degradation of metam from calcareous deposits and clays in the soil. Without being bound by theory, the cause may also be salt displacement resulting in better MITC movement in the soil profile, or a sulfur effect, that is, calcium thiosulfate, calcium chloride and/or calcium nitrate effects the pH.

In general, sodium has a negative effect on soil structure. When present in high enough quantity, sodium causes soil particles (clay particles) to deflocculate (disperse) resulting in slow water infiltration and hydraulic conductivity (water movement through the soil). Like potassium, sodium is a monovalent cation with only one positive charge with a large shell of hydration. It is this combination of factors that causes the clay particles to disperse and plug up soil pores to the extent that prevents or greatly slows down water movement. Calcium on the other hand has a slightly larger shell of hydration but two positive charges resulting in a stronger attraction for the clay particles. Calcium has 43 times the flocculating power of sodium. Clay particles stack up like little sandwiches called tactoids in the soil allowing water to infiltrate.

Gypsum can be used to as source for calcium to the soil (especially calcareous soils) but a disadvantage is its low solubility, it hence is used primarily in solid form. The claimed inorganic compounds: calcium thiosulfate (CaS₂O₃), calcium nitrate Ca(NO₃)₂ and/or calcium chloride (CaCl₂) have the right solubility and proved surprisingly stable in a concentrated solution together with soil fungicides, insecticides or fumigants, more in particular dithiocarbamate based fumigants like metam salts.

All of these products—calcium thiosulfate (CaS₂O₃), calcium nitrate (Ca(NO₃)₂) and/or calcium chloride (CaCl₂)—can be blended easily with metam sodium or metam potassium to add soluble calcium. By adding soluble calcium, sodium is displaced off of the soil exchange sites and flushed down below the root zone allowing better water penetration into the soil and more even application of the fumigant.

Of the claimed compounds, calcium thiosulfate is the most preferred as it does not contain nitrogen or chloride and is 125 times more soluble than gypsum. Another advantage of calcium thiosulfate is it contains a form of reduced sulfur that can acidify the soil releasing even more calcium.

When applied together to the subsurface of soil, the calcium thiosulfate, calcium chloride and/or calcium nitrate is believed to keep the metam from reacting with and binding to soil, being absorbed, or being converted into non-efficacious compounds. Therefore, in many soil types the applied metam may have increased efficacy.

We believe the concentrated calcium thiosulfate, calcium chloride and/or calcium nitrate combination with the dithiocarbamate has a pesticidal effect against certain soil-borne diseases, including efficacy against Verticillium and potentially against other diseases.

In another embodiment the formulations of this invention, exemplified by a concentrated calcium thiosulfate, calcium chloride and/or calcium nitrate/metam pre-mix, can be added to irrigation water. Therefore treating solution need not be concentrated but rather can be added to irrigation water. Treatment rates of greater than 30 gallons of concentrated 29% liquid calcium thiosulfate, calcium chloride and/or calcium nitrate per acre, are needed to show commercially acceptable effect on the target.

One potential issue is that dilute solutions of liquid calcium thiosulfate, calcium chloride and/or calcium nitrate, especially when the dilution water contains substantial carbonic acid and/or dissolved oxygen, can over time result in calcium thiosulfate, calcium chloride and/or calcium nitrate degradation and solid precipitation, thereby potentially plugging lines. Therefore, in one embodiment a dilute yet strong solution is desired, for example between 2% and 6% by weight of calcium thiosulfate, calcium chloride and/or calcium nitrate (and optionally metam or salt thereof) and the treatment can advantageously be followed by overwatering to flush nozzles.

In all embodiments, performance can be enhanced by addition of adjuvants, including for example additives to enhance a calcium thiosulfate, calcium chloride and/or calcium nitrate plus metam combination product, including e.g. stability/storability enhancer, odor mitigation, surfactants, and the like. Calcium thiosulfate, calcium chloride and/or calcium nitrate stability can be enhanced by addition of minor amounts of caustic, e.g., 3% or less, more typically 1.5% or less, for example 0.5% by weight or less of alkali hydroxides. In any of the above embodiments, the stability of the solution can be promoted by the addition of alkali sulfites, typically present in amounts of 1% or less, for example between 0.01 and 0.5% by weight. Various other additives, including hygroscopic gels, penetrators, and the like can also be included as adjuvants. Generally, the entire adjuvant formulation added will be less than 5% by weight of the composition, with active ingredients (fumigant and calcium thiosulfate, calcium chloride and/or calcium nitrate) and water comprising the remaining ingredients.

Of course, the calcium thiosulfate, calcium chloride and/or calcium nitrate will rapidly react in the soil despite treatments to retard degradation in water or chemical distribution lines. This is beneficial for the soil.

In a broad embodiment, one aspect of the invention is using calcium thiosulfate, calcium chloride and/or calcium nitrate, to provide a stable alkaline environment when admixed with certain fumigants. One class of fumigants particularly useful in the invention are those that are 1) degraded by direct contact with acids, but 2) are also degraded by or not effective in calcareous soils. This broad aspect of the invention may be applicable to other fumigants, especially those fumigants that do not degrade when exposed to calcium thiosulfate, calcium chloride and/or calcium nitrate.

In another embodiment of the invention the liquid calcium thiosulfate, calcium chloride and/or calcium nitrate and the fumigant can be added independently. This will require separate nozzles on the shanks, however, and multiple tanks. Such systems, where calcium thiosulfate, calcium chloride and/or calcium nitrate and fumigant are admixed on location, are less preferred as it requires multiple tanks and equipment not normally used in the industry. Such a system of multiple injection ports at different depth may be useful when treating soil at various depths, where the ratio of metam to calcium thiosulfate, calcium chloride and/or calcium nitrate in the solution may be different for solutions injected at 2 to 8 inches or at 2 to 4 inches depth as compared to a solutions injected at more than 8 inches depth.

The concentrated pre-mix of calcium thiosulfate, calcium chloride and/or calcium nitrate and Metam solution was shown to be effective to treat for late blight and Verticillium. The concentrated calcium thiosulfate, calcium chloride and/or calcium nitrate and Metam formulation is also expected to be effective in the treatment of Strawberry diseases including Charcoal rot (Macrophomina phaseolina) and Phytophthora crown rot (Phytophthora cactorum), and for Potato diseases including Fusarium Dry Rot (Fusarium solanum), Tuber Rot (Phytophthora infestans), and Black Dot (Colletotrichum coccodes). While the pesticidal effects may be additive, the presence of calcium thiosulfate, calcium chloride and/or calcium nitrate appears to reduces metam or MITC degradation by certain elements in certain soils, allowing the applied metam to be effective in soil types where it would otherwise be neutralized or less ineffective.

The invention is illustrated by the examples but is not limited to the examples.

### EXAMPLES

### Example 1: Stability of the Concentrates

Metam & calcium thiosulfate: Compatibility of calcium thiosulfate (CaTs®) and metam sodium or metam potassium were examined as follows: Stock solutions of metam sodium (42%) or metam potassium (54%) were mixed with stock solutions of calcium thiosulfate (CaTs®, 25%) in 1:1 ratios first. 50 grams of the metam samples were mixed separately with 50 grams of calcium thiosulfate and mixed well. The blends were observed for chemical changes (i.e., reactions, hydrogen sulfide generation, heat formation, or precipitation) as well as physical changes (i.e., color change, phase separation). The samples were monitored over six months period. No changes were observed. 1/9 ratios of the metam sample and CaTs® as well as 9/1 ratios were found to be stable as well.

Metam & calcium chloride: Compatibility of calcium chloride (CaCl₂, 50% solution in water) and metam sodium or metam potassium were examined as follows: Stock solutions of metam sodium (42%) or metam potassium (54%) were mixed with stock solution of calcium chloride (CaCl₂, 50%) in 1:1 ratios first. 50 grams of the metam samples were mixed separately with 50 grams of calcium chloride solution and mixed well. The blends were observed for chemical changes (i.e., reactions, hydrogen sulfide generation, heat formation, or precipitation) as well as physical changes (i.e., color change, phase separation). The samples were monitored over six months period. No changes were observed. 1/9 ratios of the metam sample and CaCl₂ as well as 9/1 ratios were found to be stable as well.

Metam & calcium Nitrate: Compatibility of calcium nitrate [Ca(NO₃)₂, 50% solution in water] and metam sodium or metam potassium were examined as follows: Stock solutions of metam sodium (42%) or metam potassium (54%) were mixed with stock solution of calcium nitrate [Ca(NO₃)₂, 50%] in 1:1 ratios first. 50 grams of the metam samples were mixed separately with 50 grams of calcium nitrate solution and mixed well. The blends were observed for chemical changes (i.e., reactions, hydrogen sulfide generation, heat formation, or precipitation) as well as physical changes (i.e., color change, phase separation). The samples were monitored over six months period. No changes were observed. 1/9 ratios of the metam sample and Ca(NO₃)₂ as well as 9/1 ratios were found to be stable as well.

The above stable concentrated liquid solutions prove very useful in the treatment of soil-borne pathogens. No precipitation was noticed so that there is little to no risk of clogging of nozzles. The compounds were found to be compatible, the liquid solutions proved to be stable and have a long shelf life. The me tam salts did not precipitate nor decompose.

The claimed stable concentrated liquid solutions of the invention will hence be useful for treating all agricultural and horticultural plants for which metam alone is useful. The claimed stable concentrated liquid solutions of the invention will hence also be useful for treating all agricultural and horticultural plants for which the particular fumigant alone is useful. The claimed stable concentrated liquid solutions of the invention allow the use of metam salts in calcareous soils too, as the inorganic calcium-containing compounds allow the metam salt to penetrate into the soil better and deeper. In particular the use of a calcium thiosulfate is beneficial, as explained supra, either alone or in combination with the calcium chloride and/or the calcium nitrate.

For the amounts of metam and of calcium thiosulfate, calcium nitrate and/or calcium chloride to use, see the preferred amounts to use as given heretofore. Preferably the stable concentrated liquid solutions of the invention are applied at a depth of 4 inches subsurface or below, the rate of application being varied in accordance with the pest to control and its severity. A person skilled in the art will be a able to adapt to the circumstances.

What is claimed:

1. A stable concentrated liquid solution, said stable concentrated liquid solution comprising:
a. between about 4% and about 30% total by weight of calcium thiosulfate, calcium chloride and/or calcium nitrate;
b. at least about 2% by weight of a soil fungicide, insecticide or fumigant; and
c. water.

2. The stable concentrated liquid solution of claim 1, wherein said stable concentrated liquid solution comprises between about 4% and about 30% total by weight of calcium thiosulfate, calcium chloride and/or calcium nitrate, and between about 4% and about 54% by weight of a soil fumigant, said fumigant comprising a dithiocarbamate.

3. The stable concentrated liquid solution of claim 2, wherein the dithiocarbamate comprises N-methyldithiocarbamate, and wherein the weight ratio of the fumigant to the calcium thiosulfate, calcium chloride and/or calcium nitrate is between about 10:1 to about 1:10.

4. The stable concentrated liquid solution of claim 1, wherein the soil fungicide, insecticide or fumigant comprises a salt of dithiocarbamate.

5. The stable concentrated liquid solution of claim 4, wherein the dithiocarbamate comprises an alkali salt of N-methyldithiocarbamate, and wherein the weight ratio of the salt of the methyldithiocarbamate to the calcium thiosulfate, calcium chloride and/or calcium nitrate is between about 10:1 to about 1:10.

6. The stable concentrated liquid solution of claim 1, wherein the fumigant comprises a salt of metam, and wherein the concentration of the salt of metam and the concentration of the calcium thiosulfate, calcium chloride and/or calcium nitrate in the concentrated solution are each greater than about 5% by weight.

7. A method of treating soil pathogens, preferably in arable soil, said method comprising the step of treating a soil with the stable concentrated solution of claim 1.

8. The method of claim 7, wherein at least a portion of the concentrated liquid solution is placed at a depth about 4 inches subsurface or below.

9. A stable concentrated liquid solution, said stable concentrated liquid solution comprising:
a. between 4% and about 50% total by weight of calcium thiosulfate, calcium chloride, and/or calcium nitrate;
b. between 4% and about 56% by weight of a fumigant, said fumigant comprising a salt of methydithiocarbamate or other MITC generator; and
c. water.

10. A method of treating disease in arable soil prior to crop planting, comprising: applying to the surface or subsurface of the arable soil a stable aqueous solution comprising an MITC-generating fumigant and one or more of calcium thiosulfate, calcium chloride and/or calcium nitrate prior to planting, wherein the amount of calcium thiosulfate, calcium chloride and/or calcium nitrate added is at least about 137 kg/ha.

11. The method of claim 10 wherein at least a portion of the aqueous solution is applied below the soil surface.

12. The stable concentrated liquid solution of claim 4 wherein the salt of dithiocarbamate is selected from the group consisting of alkali salts of dithiocarbamate, a sodium salt of N-methyldithiocarbamate, a potassium salt of N-methyldithiocarbamate and mixtures thereof.

13. The stable concentrated liquid solution of claim 1 wherein said stable concentrated liquid solution comprises between about 4% and about 30% total by weight of calcium thiosulfate, calcium chloride and/or calcium nitrate, and between about 4% and about 54% by weight of a soil fumigant, said fumigant comprising a N-methyldithiocarbamate or a salt of dithiocarbamate.
